(19) United States
(12) Patent Application Publication
(10) Pub. No.: US 2011/0115600 A1
(43) Pub. Date: May 19, 2011

(54) MAGNETIC CORE AND TRANSFORMER HAVING THE SAME

(75) Inventors: Tang-Bin Shen, Shanghai (CN); Jun-Feng Guan, Shanghai (CN); Yun-Feng Wang, Shanghai (CN)

(73) Assignee: DELTA ELECTRONICS, INC., Taoyuan Hsien (TW)

(21) Appl. No.: 12/946,083

(22) Filed: Nov. 15, 2010

(30) Foreign Application Priority Data
Nov. 17, 2009 (CN) 200910224544.5

(51) Int. Cl. H01F 27/24

(52) U.S. Cl. 336/221; 336/233

(57) ABSTRACT

A magnetic core is disclosed. The magnetic core comprises a first side post with a first inner wall, a second side post opposite to the first side post with a second inner wall, an annular space enclosed by the first inner wall and the second inner wall, a central post with a second axis, and a core base connected with the first post, the second post, and the central post. The annular space comprises a first axis, a first opening, and a second opening. The first opening and the second opening are oppositely and respectively formed between the first side post and the second side post. The second axis of the central post in the annular space is disposed between the first axis and one of the first opening and the second opening.

### FIELD OF THE INVENTION

The present invention relates to a magnetic core and a magnetic component containing such magnetic core, and more particularly to a magnetic core with an improved longitudinal axis and a transformer containing such improved magnetic core, for use with a variety of different electronic devices.

### BACKGROUND OF THE INVENTION

A magnetic core is a structure on which the windings of electric transformers and other wound components are formed. As known, magnetic core design is critical in optimizing the performance of most magnetic components as well as the electronic devices which are equipped with the same. Nowadays, it becomes even more critical when some major design guidelines, such as safety, flexibility in customization and mass-production, are urgently underlined by recent trends in the industry.

FIGS. 1A and 1B respectively illustrate a front and top view schematically showing a conventional magnetic core, and a top perspective view of the same. The illustrated conventional magnetic core is a PJ type magnetic core in shape. The magnetic core 10 mainly comprises a first post 12, a second post 13, and a central post 11. The three posts are extended from a core base 14. An annular space 21 for accommodating a winding coil 30 is enclosed by the first post 12 and the second post 13. The central post 11 has a second axis 111, and the annular space 21 has a first axis 211. As shown in FIG. 1B, the central post 11 and the annular space 21 have a common axis according to their longitudinal axes. In other words, they are coaxial. In fabricating, the magnetic core 10 is normally assembled with the winding coil 30 and a bobbin 31 so as to construct a conventional magnetic component, such as a transformer. The winding coil of a transformer may further include a primary winding coil or an input winding coil, and a secondary winding coil or an output winding coil (not shown). However, the bobbin 31 for being mounted by the winding coil 30 and being an insulator between the magnetic core 10 and other components can be replaced by other alternatives which are well known in the art.

In FIG. 2, a conventional transformer 1 is illustrated. The annular space 21 has a first opening 213 and a second opening 214. The two openings are formed between the first post 12 and the second post 13. As illustrated in FIG. 2, there is spare room in the annular space 21 by the first opening 213 when there is no space left by the second opening 214. Obviously, the problem comes from the failure to make the best of the overall availability of the winding window of the magnetic core 10. The failure to optimize the availability of the winding window results in a couple of possible disadvantages, for example, the disadvantage of competitiveness in size and certain electromagnetic performance, and the struggles in design and fabrication phases. The conventional arrangement also requires paying more attention to the output of the transformer 1 since there might be a safety issue resulting from the crowded and limited working space therein.

The further disadvantage may result from the need for design flexibility. The circuits in use, such as an LLC circuit, full-bridge circuit, or half-bridge circuit etc., can vary depending upon the individual design needs, and some of them would require performing the way that the output current of the transformer 1 is greater than the input current. As a result, the output winding coil is normally subject to specific approach by using, for example, a copper foil laminate. This arrangement would require greater room in the annular space 21 by the output side of the magnetic core 10 so as to accommodate the winding coil with an output current larger than input. Besides, in some cases, the output side of the bobbin 31 would also require more space to settle the connection, such as soldering connection, between the output of the winding coil 30 and, for example, an output wire in order to transport the output power of the transformer 1. It is easily to be understood that in some other occasions to leave larger space in the annular space 21 by the input side of the magnetic core 10, instead of the output side, is probably more desirable and preferred. Apparently, a magnetic core which is capable to meet the needs for increasing design flexibility, higher safety, simpler construction, and is suitable for use in various electronic devices is in demand.

### SUMMARY OF THE INVENTION

It is an object of an embodiment of the present invention to provide a magnetic core and a transformer having such magnetic core in which the availability of the winding window of the magnetic core is optimal.

It is another object of an embodiment of the present invention to provide a magnetic core and a transformer having such magnetic core in which the magnetic core has an advantage of reducing the size of magnetic cores and transformers for use in various electronic devices, and high flexibility to meet customized design requirements.

It is another object of an embodiment of the present invention to provide a magnetic core and a transformer having such magnetic core in which the magnetic core is easily to be assembled with other components in fabrication.

It is another object of an embodiment of the present invention to provide a magnetic core and a transformer having such magnetic core in which the magnetic core can reduce safety issues while in use.

In accordance with an aspect of the present invention, there is provided a magnetic core comprising a first side post with a first inner wall, a second side post opposite to the first side post with a second inner wall, an annular space enclosed by the first inner wall and the second inner wall, a central post with a second axis, and a core base connected with the first post, the second post, and the central post. The annular space comprises a first axis, a first opening, and a second opening. The first opening and the second opening are oppositely and respectively formed between the first side post and the second side post. The second axis of the central post in the annular space is disposed between the first axis and one of the first opening and the second opening. In one embodiment, one of the first opening and the second opening is greater than the other one.

In accordance with an aspect of the present invention, there is provided a transformer comprising a magnetic core and a winding coil. The magnetic core of this invention is described as above. The winding coil comprises an input winding coil and an output winding coil which are placed on the core base and accommodated in the annular space of the magnetic core.

The above contents of the present invention will become more readily apparent to those ordinarily skilled in the art after reviewing the following detailed description and accompanying drawings, in which:

### BRIEF DESCRIPTION OF THE DRAWINGS

FIG. 1A illustrates a front and top view schematically showing a conventional magnetic core;

FIG. 1B illustrates a top perspective view of the conventional magnetic core shown in FIG. 1A;

FIG. 2 illustrates a top perspective view schematically showing the structure of a conventional transformer;

FIG. 3 illustrates a top perspective view schematically showing a magnetic core according to one embodiment of the invention;

FIG. 4 illustrates a top perspective view schematically showing the structure of a transformer according to one embodiment of the invention;

FIG. 5 illustrates a top perspective view schematically showing a magnetic core according to another embodiment of the invention;

FIG. 6A illustrates a front and top view schematically showing one embodiment of the magnetic core according to FIG. 5;

FIG. 6B illustrates a top perspective view of the magnetic core shown in FIG. 6A;

FIG. 7A illustrates a front and top view schematically showing another embodiment of the magnetic core according to FIG. 5; and

FIG. 7B illustrates a top perspective view of the magnetic core shown in FIG. 7A.

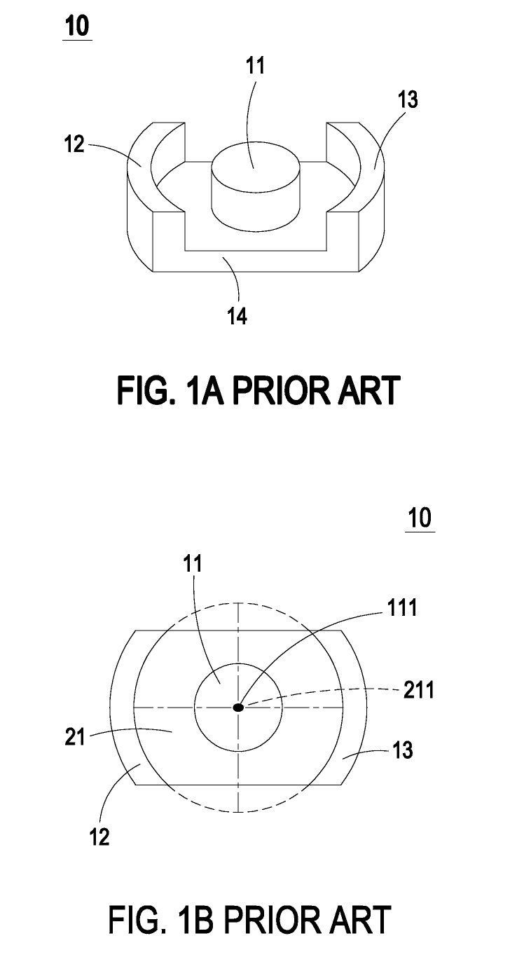

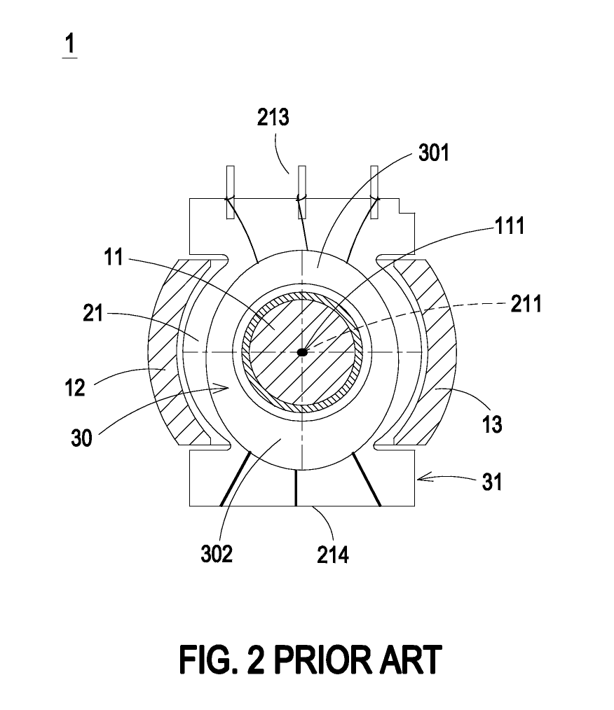

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

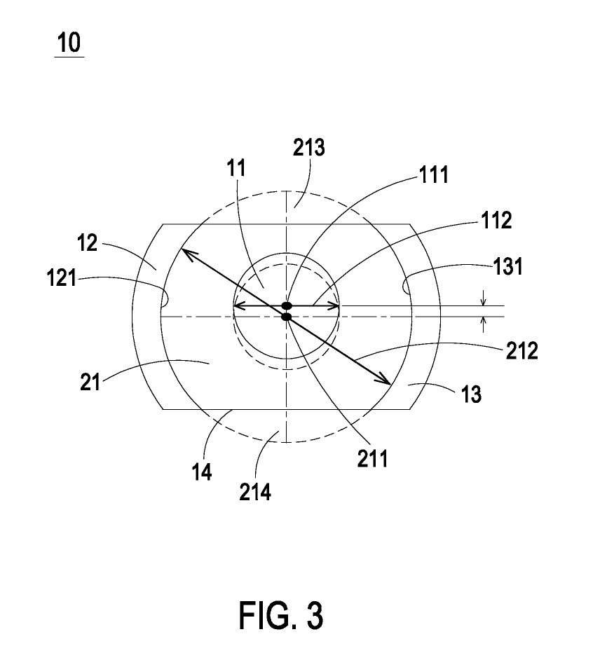

FIG. 3 is a top perspective view schematically showing a magnetic core according to one embodiment of the invention. It illustrates a magnetic core 10 with a PJ type magnetic core in shape. The magnetic core 10 is a ferrite core which comprise a first side post 12 with a first inner wall 121, a second side post 13 opposite to the first side post 12 with a second inner wall 131, an annular space 21 enclosed and defined by the first inner wall 121 and the second inner wall 131, a central post 11 with a second axis 111, and a core base 14 beneath the annular space 21 connected with the first post 12, the second post 13, and the central post 11. The annular space 21 comprises a first axis 211, a first opening 213, and a second opening 214. The first opening 213 and the second opening 214 are oppositely and respectively formed between the first side post 12 and the second side post 13. The second axis 111 of the central post 11 in the annular space 21 is disposed between the first axis 211 and one of the first opening 213 and the second opening 214. As illustrated, the first axis 211 is the center of the annular space 21, and the second axis 111 is the longitudinal axis of the central post 11. The annular space 21 further comprises a first diameter 212 passing through the first axis 211, and the central post 11 further comprises a second diameter 112 passing through the second axis 111. As compared with the first axis 211 of the annular space 21, the second axis 111 of the central post 11 is off-centre by a distance from said first axis 211, and disposed between the first axis 211 and the first opening 213. A clearer picture about the described off-centre can be viewed by checking on the first diameter 212 and the second diameter 112 which are marked and shown in the figures.

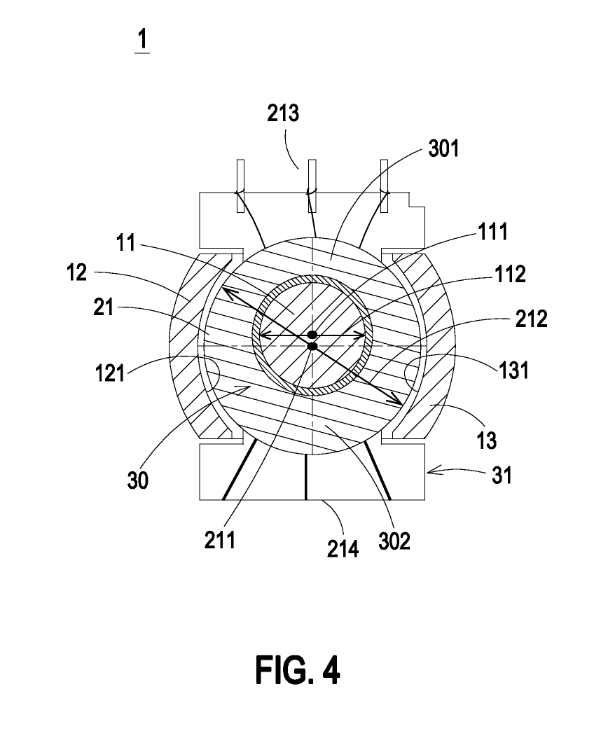

Referring to FIG. 4, the magnetic core illustrated in FIG. 3 is further assembled with a winding coil 30 and a bobbin 31 to form the transformer 1. The winding coil 30 comprises an input winding coil 301 and an output winding coil 302. The winding coil 30 is assembled with the bobbin 31, placed on a core base 14, and accommodated in the annular space 21. In practical application, the material of the foregoing coils can vary. In this embodiment, the output winding coil 302 is a copper foil laminate. As known to us, in some occasions or embodiments, other alternatives can be taken for insulation and dealing with the connection between the transformer 1 and other components, and the bobbin 31 can thus be eliminated.

As illustrated in FIG. 4, all the annular space 21 has been filled and occupied due to relocating the second axis 111 from the first axis 211 toward the first opening 213. In this embodiment, the first opening 213 is an exit of the input winding coil 301, and the second opening 214 is an exit of the output winding coil 302. In particular, the second axis 111 can be relocated from the first axis 211 toward either the first opening 213, as illustrated here, or the second opening 214. The location of the second axis 111 depends upon what different design guidelines are practically drawn in the case. In addition, even though a PJ type magnetic core is illustrated therein, the magnetic cores with other types in shape are also possible, such as a PQ type, an EQ type, an RM type, an ER type, a PM type magnetic core in shape. In this embodiment, the output winding coil 302 is capable to provide multiple power outputs by several ways which are well known in the art.

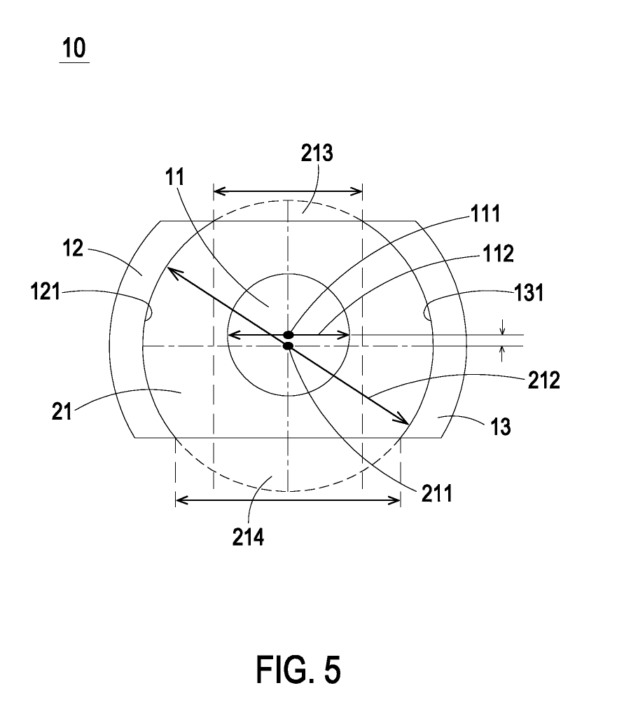

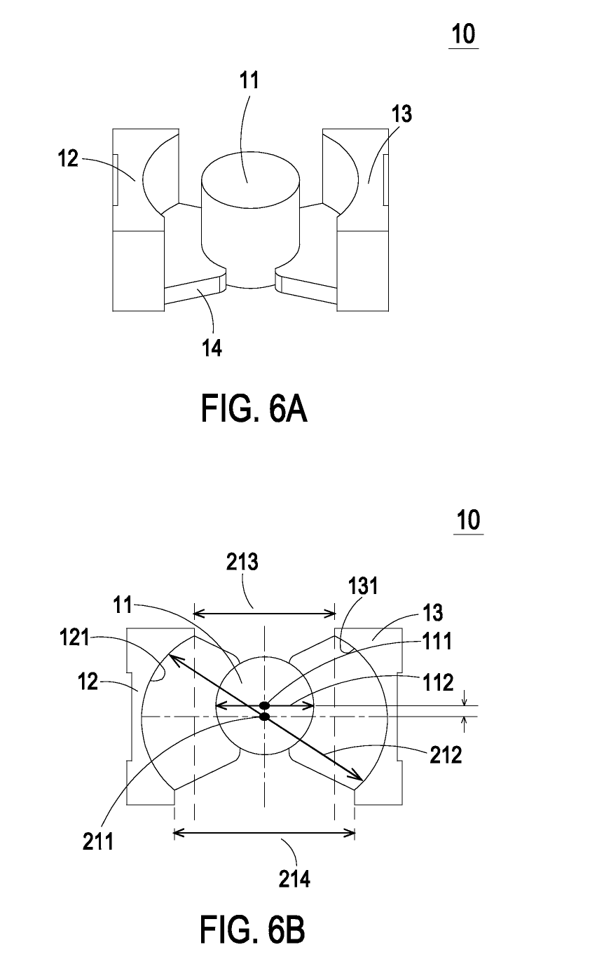

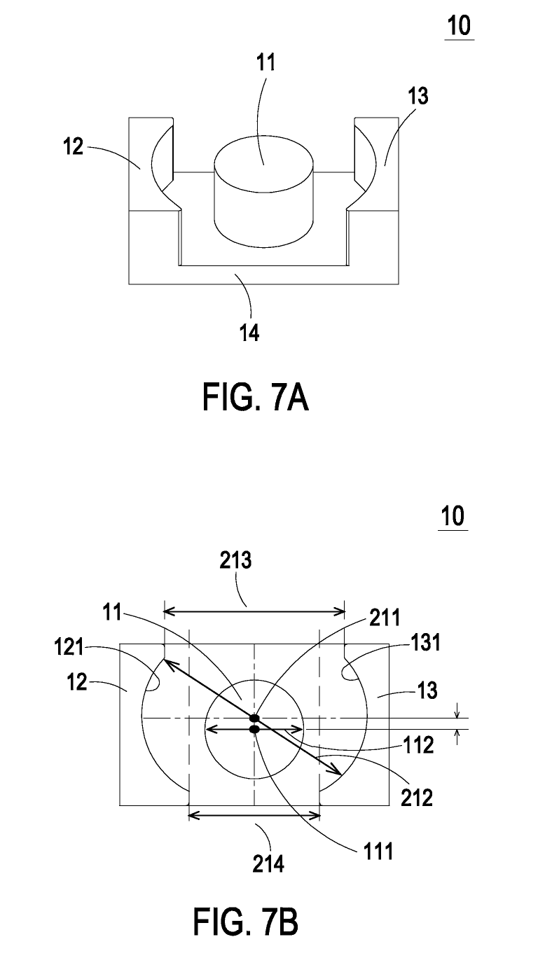

FIG. 5 illustrates a top perspective view schematically showing a magnetic core according to another embodiment of the invention. In this embodiment, the second opening 214 is not equal to, but greater than, the first opening 213 in opening. This arrangement is further beneficial to get over the transformer's output issues in question. In other situations, it may be desirable to reverse them in order to serve the practical design purposes. For example, FIG. 6A shows one embodiment of the magnetic core according to FIG. 5, and FIG. 6B is the top perspective view of the same. In this embodiment, this is a PQ type magnetic core in shape; the second axis 111 of the central post 11 is positioned close to the first opening 213, and the second opening 214 is greater in opening than the first opening 213. Another example is provided in FIGS. 7A and 7B which illustrate an EQ type magnetic core according to one embodiment of the invention as illustrated in FIG. 5. In this embodiment, the second axis 111 of the central post 11 is positioned close to the second opening 214, and the second opening 214 is smaller in opening than the first opening 213. As already discussed above, the variant means is taken based upon the different design guidelines drawn in the case.

According to the foregoing description, the present invention has disclosed a magnetic core which is capable to increase more availability of winding window so as to provide more flexibility in design, solve the problems occurred in the conventional way, and is suitable for a wild variety of electronic devices, such as a switching power supply.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic core, comprising:
a first side post comprising a first inner wall;
a second side post opposite to said first side post and comprising a second inner wall;
an annular space enclosed by said first inner wall and said second inner wall and comprising a first axis, a first opening and a second opening, wherein said first opening and said second opening are oppositely and respectively formed between said first side post and said second side post;
a central post positioned in said annular space comprising a second axis disposed between said first axis and one of said first opening and said second opening; and
a core base positioned beneath said annular space and connected with said first side post, said second side post, and said central post.

2. The magnetic core according to claim 1 wherein said first axis is the center of the annular space.

3. The magnetic core according to claim 1 wherein said second axis is the longitudinal axis of the central post.

4. The magnetic core according to claim 1 wherein said first opening is an exit of an input winding coil of a transformer.

5. The magnetic core according to claim 4 wherein said second opening is an exit of an output winding coil of said transformer.

6. The magnetic core according to claim 5 wherein said second axis is disposed between said first axis and said first opening.

7. The magnetic core according to claim 5 wherein said second opening is greater in opening than said first opening.

8. The magnetic core according to claim 1 wherein said magnetic core is a ferrite core and is one of a PJ type, a PQ type, an EQ type, an RM type, an ER type, and a PM type magnetic core in shape.

9. A transformer, comprising:
a magnetic core comprising:
a first side post comprising a first inner wall;
a second side post opposite to said first side post and comprising a second inner wall;
an annular space enclosed by said first inner wall and said second inner wall and comprising a first axis, a first opening and a second opening, wherein said first opening and said second opening are oppositely and respectively formed between said first side post and said second side post;
a central post positioned in said annular space and comprising a second axis disposed between said first axis and one of said first opening and said second opening; and
a core base positioned beneath said annular space and connected with said first side post, said second side post, and said central post; and
a winding coil accommodated in said annular space and comprising an input winding coil and an output winding coil.

10. The transformer according to claim 9 wherein said first axis is the center of said annular space.

11. The transformer according to claim 9 wherein said second axis is said longitudinal axis of said central post.

12. The transformer according to claim 9 wherein said first opening is an exit of said input winding coil.

13. The transformer according to claim 12 wherein said second opening is an exit of said output winding coil.

14. The transformer according to claim 13 wherein said second axis is disposed between said first axis and said first opening.

15. The transformer according to claim 13 wherein said second opening is greater in opening than said first opening.

16. The transformer according to claim 9 wherein said magnetic core is a ferrite core and is one of a PJ type, a PQ type, an EQ type, an RM type, an ER type, and a PM type magnetic core in shape.

17. The transformer according to claim 9 wherein said output winding coil is a copper foil laminate.

18. The transformer according to claim 9 wherein said output winding coil is capable to provide multiple power outputs.

19. The transformer according to claim 9 wherein said transformer is for use in a switching power supply.
